(19) United States
(12) Patent Application Publication
(10) Pub. No.: US 2004/0134928 A1
(43) Pub. Date: Jul. 15, 2004

(54) Methods and apparatus for storing and dispensing coasters

(76) Inventors: Nancy Ann Wagner, Atlanta, GA (US); Gina Farra, Fairfax, VA (US); Ronald Dampier, Ocala, FL (US); Jennifer Koets Nance, Atlanta, GA (US); Margaret W. Parrish, Temple, GA (US); Kelly M. Kozel, Atlanta, GA (US); Paul Anthony Morgan, Atlanta, GA (US)

Correspondence Address: NORA M. TOCUPS, P.O BOX 698, 140 PINECREST AVE, DECATUR, GA, 30030, US

(21) Appl. No.: 10/688,569

(22) Filed: Oct. 17, 2003

Related U.S. Application Data
(60) Provisional application No. 60/439,169, filed on Jan. 9, 2003.

(51) Int. Cl. A47F 1/04; G07F 11/16

(52) U.S. Cl. 221/303

(57) ABSTRACT

A dispenser for coasters including a housing for storing coasters. An embodiment is a cylindrical can for receiving a stack of round coasters. The housing includes a dispensing aperture set near the bottom of the housing and large enough to allow a coaster to pass through to the outside of the housing. A pushing aperture is also set near the bottom of the housing, but set opposite to the dispensing aperture. The pushing aperture is large enough to allow access to a coaster in the interior of the housing and to allow the coaster to be pushed towards the dispensing aperture whereupon the coaster is dispensed.

The housing may include a removable top for adding coasters to the dispenser. The removable top may include a force member disposed into the interior of the housing so as to exert force on the coasters and towards the bottom of the housing.

### RELATED APPLICATION

This application claims priority to and the benefit of the prior filed co-pending and commonly owned provisional patent application, which has been assigned U.S. Patent Application Serial No. 60/439,169 entitled “Methods and Apparatus for Storing and Dispensing Coasters,” filed on Jan. 9, 2003, and incorporated herein by this reference.

### FIELD OF THE INVENTIONS

These inventions relate in general to the field of storage and dispensing devices. These inventions particularly relate to the field of storage and dispensing devices for coasters or like items.

### BACKGROUND

A coaster is a protective device used to minimize damage to a surface covered by the coaster. Typically, coasters are used to protect furniture from damage that otherwise may be caused by containers placed directly on the furniture's bare surface. For example, a coaster may be placed under a glass of ice water to protect the underlying surface from damage that may be caused by condensation that runs down the outside of the glass. Advantageously, the coaster absorbs or otherwise diverts the moisture so as to avoid a water mark on or other damage to the protected surface.

A drawback to using coasters is that a coaster is often left wherever it was last used. Coasters that are left scattered after use may give their environment a messy, unorganized, and undesirable appearance. Also, coasters that are left scattered in an environment may make protective use of a coaster more difficult because a coaster may not be easy to locate and use. Decreased use of coasters may lead to increased damage to furniture and other objects in the environment.

When not left wherever last used, coasters are most commonly placed in a stack or in a pile in a relatively convenient location, such as on a table or bar. Stacking the coasters saves space and keeps the coasters readily available for use.

Stacking coasters, however, has disadvantages. Coasters that are carelessly thrown into a stack or heap can look untidy, and give the environment a disorganized or even dirty appearance. Moreover, a stack of more than about five or six coasters can become unbalanced, and is easily knocked over and the coasters scattered. As a result, coasters that are slovenly stacked or over-stacked can create an eyesore that takes away from the aesthetics of the environment.

Another problem with stacking coasters is that of uneven use of the coasters in the stack. Typically, the coasters at the top of the stack are used repeatedly while coasters in the bottom of the stack are not used as often. The coasters at the top generally remain the same because after a coaster's use, it is typically returned to the top of the stack. The coasters in the bottom of the stack rarely work their way up to the top. As a result of their repeated use, the top coasters may be become soiled, and may lose some or all of their functionality such as absorptiveness. The uneven use of the coasters in the stack leads to the soiled, less functional coasters being used over and over again. The repeated use of soiled, dysfunctional coasters may give the environment a seedy, undesirable feel.

Another function of a coaster may be as a vehicle to carry advertising. Beverage manufacturers especially have seized the opportunity to advertise their products on coasters. A beverage manufacturer may provide vendors with free coasters to use with the coasters bearing beverage advertisements. A coaster placed before a patron in a bar or restaurant is a point-of-sale opportunity to advertise the availability of certain products.

As an advertising means, coasters and their storage and use can affect the image of a product. For example, assume a set of coasters bears advertising for beverage X. Assume the coasters are messily left scattered after use in a restaurant, and that a slovenly pile of the coasters sits at one end of the restaurant's bar. The impression given by the messily scattered coasters and the slovenly pile of coasters is that of products that are used-up, and not valued. The same impression may carry over to beverage X advertised on the coasters. Thus, a customer may, at least subconsciously, gain a negative impression of beverage X through messy and slovenly use of the coasters bearing its advertising.

To address the unpleasant aesthetics and problems of scattered coasters or a stack or pile of coasters, coasters may be collected and stored out of sight such as in a cupboard, under a bar, etc. Hiding coasters, however, has downsides. In particular, the usage of coasters may be greatly reduced because stored coasters become more difficult to access and therefore less convenient to use. Additionally, when not in plain sight, coasters are often not used because they are simply forgotten. Decreased use of coasters, as mentioned above, can lead to increased damage to furniture and other surfaces. Also, decreased use of coasters and hiding coasters negatively affects the advertising value of the coasters.

The protective and advertising uses of coasters are of such benefit that their use is commonplace. Yet, the advantages of coaster use would be even greater if at least some of the drawbacks of coaster use were eliminated.

In sum, there is a need for handling coasters so as to increase their use by making coasters easily locatable and readily accessible. There is a need for handling coasters so that their use and storage does not negatively affect the aesthetics of their environment.

In particular, there is a need for handling coasters so as to avoid or eliminate the problems accompanying the practice of stacking or piling coasters. These problems include at least the often untidy, messy appearance of the stack or pile, the over-stacking of coasters in the stack or pile, and the repeated return of used coasters to the top of the stack or pile without use of coasters in the bottom of the stack. By addressing the needs mentioned above, the solutions would also go a long way as well to advancing the advertising value of coasters.

### SUMMARY OF THE INVENTIONS

The inventions relate to methods and apparatus for storing and dispensing coasters. A coaster dispenser or dispensing method according to the inventions may include a housing for storing coasters. The housing includes a dispensing aperture set near the bottom of the housing. The dispensing aperture is large enough to allow a coaster to pass through to the outside of the housing. A pushing aperture is also set near the bottom of the housing, but set opposite to the dispensing aperture. The pushing aperture is large enough to allow access to a coaster in the interior of the housing and to allow the coaster to be pushed towards the dispensing aperture whereupon the coaster is dispensed from the housing.

Advantageously, the inventions provide solutions for the handling of coasters so as to increase their use by making coasters easily locatable, readily accessible, and a positive influence on the aesthetics of their environment. The inventions substantially eliminate the problems described in the background regarding the practice of stacking or piling coasters. The inventions provide methods and apparatus for dispensing coasters that avoid the untidy, messy appearance and problems associated with a coaster stack or pile. Moreover, the inventions address the problems associated with the repeated re-use of the same coasters by providing for a rotation through coaster use. By substantially solving these problems, the inventions also increase the advertising value of coasters.

More particularly, the inventions include multiple embodiments including an apparatus to dispense coasters. The apparatus includes a housing for storing a stack of coasters. The housing may be a cylindrical can such as a beverage can. Each coaster in the stack may be substantially round in shape and be of substantially the same size as each of the other coasters in the stack. If the housing is a cylindrical can, and the coasters are substantially round, then the diameter of the cylindrical can may be just slightly larger than the diameters of the coasters so that the cylindrical can maintains the coasters in the stack.

The housing also includes a dispensing aperture near the bottom of the housing. The dispensing aperture may be of a size large enough to allow the bottom coaster of the stack of coasters to pass from the stack of coasters through the dispensing aperture to the outside of the housing. In some cases, the dispensing aperture is large enough to allow only the bottom coaster to pass through to the outside of the housing. The dispensing aperture may be sized to be only slightly wider than a diameter of the bottom coaster.

In an exemplary embodiment, the dispensing aperture in the housing is an elongated half circle having a flat side and an arc side. The elongated half circle is disposed so that the flat side is nearer the bottom of the housing and the arc side rises about the flat side. The flat side of the elongated half circle is perpendicular to a vertical axis of the stack of coasters in the housing. Alternatively, the flat side may be parallel to the bottom of the housing or parallel to the sides of the coasters. To allow the bottom coaster to pass through the dispensing aperture, the flat side of the dispensing aperture's elongated half circle is slightly longer (or wider) than a diameter of the bottom coaster of the stack of coasters.

Advantageously, in this embodiment, the arc side of the elongated half circle of the dispensing aperture prevents dispensing of any coaster other than the bottom coaster through the dispensing aperture. Portions of the arc side of the dispensing aperture's elongated half circle hold back the coasters immediately above the bottom coaster in the housing so that only the bottom coaster is dispensed.

In addition, the housing includes a pushing aperture near the bottom of the housing with the pushing aperture being set opposite to the dispensing aperture. The pushing aperture is of a size large enough to allow access to the bottom coaster for pushing the bottom coaster towards the dispensing aperture of the housing. This embodiment allows for the storing of coasters in the housing, and for dispensing of coasters one-by-one by using the pushing aperture to access and push the bottom coaster through the dispensing aperture to the outside of the housing.

An embodiment of the apparatus for dispensing coasters may include top member removable to and from the housing. For example, the top member may be removed to replenish the stack of coasters in the housing with additional coasters. The top member may include an underside and a top side. The top side may include a ring pull to aid in removing the top member from the housing. The underside faces into the interior of the housing. The underside may have a force member disposed thereon. For example, the force member may be disposed from the underside of the top member into the interior of the housing. The force member may be configured so as to touch the stack of coasters and to exert force on the stack of coasters and towards the bottom of the housing. In other words, the force member is adding a “push” to the pull of gravity so that the stack of coasters settles into the bottom of the interior of the housing of the dispensing apparatus.

In an embodiment of the dispensing apparatus, a stack of coasters may be encompassed or enveloped by a sleeve such as a plastic sleeve or shrink wrap. The sleeve enhances the ability to load and re-load coasters into the housing of the apparatus. To allow for dispensing of the coasters through use of the push aperture and dispensing aperture, the sleeve includes perforations that conform to the apertures.

The inventions also include methods for storing and dispensing coasters. For example, an exemplary method provides for placing a plurality of coasters in a housing. This housing includes a dispensing aperture near the bottom of the housing, a pushing aperture opposite to the dispensing aperture and near the bottom of the housing. Per this method, the pushing aperture is used to access a bottom coaster of the plurality of coasters and to exert pressure on the bottom coaster to move the bottom coaster through the dispensing aperture.

The exemplary method also may include fitting a top member onto the top of the housing. The top member includes a force member disposed on the underside of the top member. The force member extends into the interior of the housing so as to touch the stack of coasters and to exert force on the stack of coasters with the force directed towards the bottom of the housing. In this embodiment, the top member may be removed from the housing by using a pull ring disposed on the outside of the top member. The exemplary method further may include an action of causing the stack of coasters to be enveloped by a sleeve. The sleeve includes a front perforation conforming to the size of the dispensing aperture of the housing and includes a rear perforation conforming to the size of the pushing aperture.

In sum, the inventions provide solutions for the handling of coasters so as to increase their use by making coasters easily locatable, readily accessible, and a positive influence on the aesthetics of their environment. The inventions provide methods and apparatus for dispensing coasters that avoid the untidy, messy appearance and problems associated with a coaster stack or pile. Moreover, the inventions address the problems associated with the repeated re-use of the same coasters by providing for a rotation through coaster use. By substantially solving these problems, the inventions also increase the advertising value of coasters.

These and other features and advantages of the methods and apparatus according to the inventions may be more clearly understood and appreciated from a review of the following detailed description of the exemplary embodiments and by reference to the appended drawings and claims.

### BRIEF DESCRIPTION OF THE DRAWINGS

FIG. 1 is a perspective view of an exemplary embodiment of a coaster dispenser according to the inventions.

FIG. 2 is a perspective view of an alternative exemplary embodiment of a coaster dispenser according to the inventions.

FIG. 3 is a perspective view of an exemplary embodiment of a coaster dispenser in open position and a stack of coasters according to the inventions.

FIG. 4 is a perspective view of an exemplary embodiment of a dispenser top according to the inventions.

FIG. 5 is a rear view showing hidden lines of an exemplary embodiment of a coaster dispenser according to the inventions.

FIG. 6 is a front view showing a partial section of an exemplary embodiment of a coaster dispenser according to the inventions.

FIG. 7 is a front view showing a partial section of an exemplary embodiment of a coaster dispenser in closed position according to the inventions.

FIG. 8 is a perspective view of an exemplary embodiment of a stack of coasters within a coaster dispenser according to the inventions.

FIG. 9 is a perspective view of an exemplary embodiment of a coaster being dispensed from the coaster dispenser according to the inventions.

### DETAILED DESCRIPTION

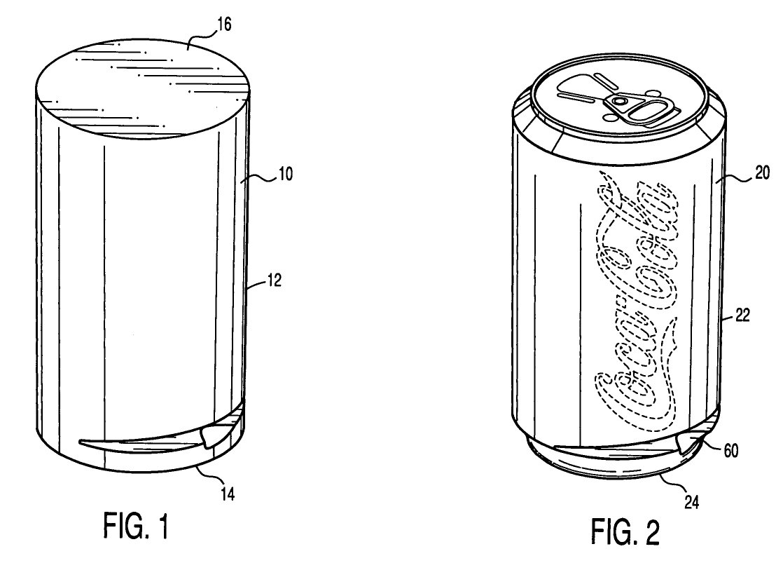

With reference now to the drawings, and in particular to FIGS. 1 through 9 thereof, exemplary apparatus and methods embodying the principles and concepts of the inventions are now described.

An Exemplary Embodiment of a Coaster Dispenser—FIG. 1

FIG. 1 illustrates an exemplary embodiment of a coaster dispenser 10 according to the inventions. As noted in the summary, an apparatus for dispensing coasters may include a housing 12 (also referred to as a sidewall). In the example illustrated in FIG. 1, the housing is cylindrical (also referred to as tubular). The housing may be of any appropriate material such as metal (such as aluminum or alloy), plastic, cardboard or other paper products, glass, ceramics, etc.

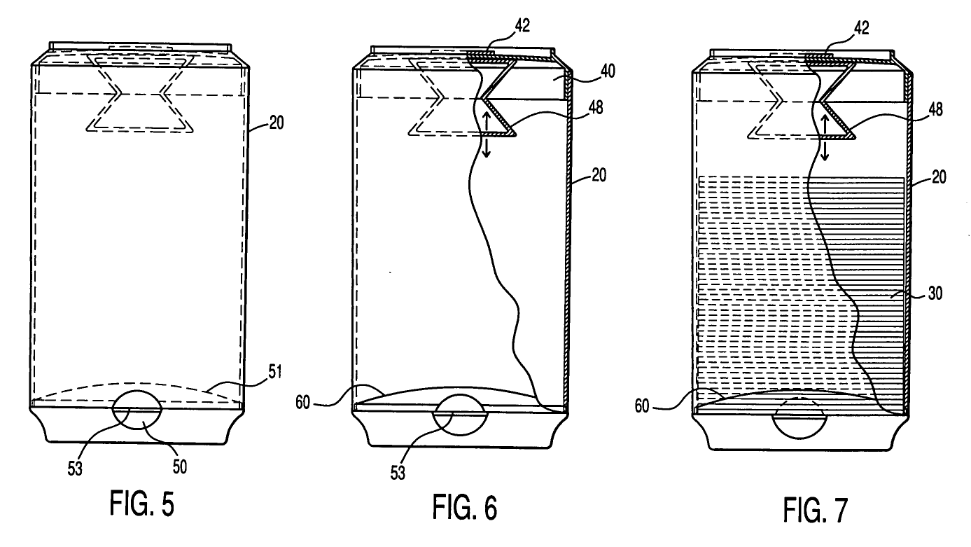

The illustrated coaster dispenser 10 includes sidewall 12, a bottom member 14, and a top member 16. Sidewall 12 includes two substantially diametrically opposed apertures (described in further detail in relation to FIG. 5 and FIG. 6) near the bottom of the sidewall 12. As illustrated, dispensing aperture 13 is shown. The other aperture, the pushing aperture, is not visible in FIG. 1, but is diametrically opposite and centered with respect to dispensing aperture 13. By accessing a coaster inside the housing 12 through use of the pushing aperture, the coaster may be pushed towards the dispensing aperture 13 and dispensed out of the housing 12.

As noted, the apertures are set near the bottom of the housing 12 or near the bottom member 14 of the coaster dispenser 12. The apertures may be set in any one of several ways. For example, the two substantially diametrically opposed apertures may be entirely within the sidewall 12. A bottom member 14 may be attached to the bottom of a sidewall 12 to form a closed bottom of a coaster dispenser 10. Alternatively, the sidewall 12 and the bottom member 14 may be formed as a single unit. Additionally and/or alternatively, the two diametrically opposed apertures may be near or at the top of the bottom member 14 of a coaster dispenser 10. As yet another example, the two diametrically opposed apertures may be formed so that each aperture occupies a portion of both the sidewall 12 and the bottom member 14.

FIG. 1 also illustrates a top member 16 used with the housing 12. The top member 16 may be removably secured to the top of the sidewall 12 to form an enclosed coaster dispenser. Alternatively, a coaster dispenser (not illustrated) may not have a top member, but rather, may have a top opening for the easy addition of coasters.

An Alternative Exemplary Environment of a Coaster Dispenser—FIG. 2

FIG. 2 illustrates an exemplary embodiment of an alternative coaster dispenser 20. An alternative coaster dispenser 20 may also be referred to as a dispenser can. A dispenser can 20 may be substantially shaped like a beverage can. For example, a dispenser can 20 may be a replica of a soda can. Additionally, a replica soda can may include artwork similar to an actual soda can such as a company logo (as shown in ghost lines). For simplicity, the dispenser can 20 is utilized for the remainder of the description to illustrate an exemplary embodiment of the inventions. Use of a dispenser can 20 for the discussion below does not preclude interchanging the use of coaster dispenser 10 or alternative variations of dispensers obvious to those skilled in the art. Thus, all exemplary embodiments and features described in relation to a dispenser can 20 may also be associated with a coaster dispenser 10 and vice versa. For example, similar to a coaster dispenser 10, a dispenser can 20 has a can sidewall 22, a can bottom 24 and a can top 40. As a further example, can sidewall 22, can bottom 24 and can top 40 are attached to and interact with a dispenser can 20 in the same manner that sidewall 12, bottom member 14 and top member 16 are attached to and interact with a coaster dispenser 10, respectively. Additionally, the dispenser can 20 may also have two substantially diametrically opposed apertures (described in further detail in relation to FIG. 5 and FIG. 6) including front (also referred to as dispensing) aperture 60.

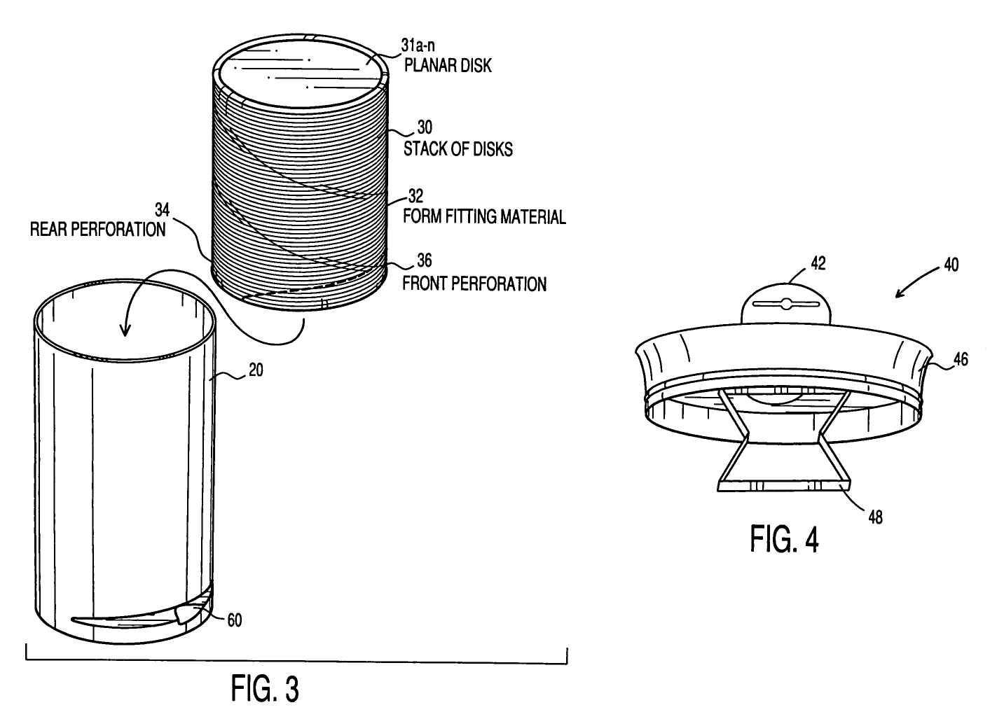

Exempilar Embodiment of Coasters and Dispenser in Open Position—FIG. 3

FIG. 3 illustrates an exemplary embodiment of a stack of coasters 30 and a dispenser can 20 in an open position. A coaster also may be referred to as a disk or a planar disk. A coaster such as may be used in the inventions described herein may be made of any appropriate material such as cardboard or other paper products, plastic, cork, etc.

The illustrated stack of disks 30 includes a plurality of planar disks 31a-n. The planar disks 31a-n, also referred to as disks or coasters, may be stacked substantially parallel to each other forming a vertical stack of planar disks 31a-n. For example, a stack of disks may be a stack of beverage coasters and each planar disk may be a coaster. The disks may be inserted one-by-one into the dispenser can 20, or the disks can be formed into a stack (of whatever appropriate number) and the stack inserted into the dispenser ca 20.

To aid in inserting the disks into the dispenser can 20, a number of disks may be formed into a stack and enveloped, encompassed, or encased within a liner or sleeve, which may be of a form fitting material or a material holding its own form. FIG. 1 illustrates a stack of disks 30 held together with a form fitting material 32. For example, a form fitting material 32 may be shrink-wrap material, or any other shape retaining material, sized to fit around the peripheral edges of the stack of disks 30. The form fitting material 32 may fit snugly around the peripheral edge of the stack of disks 30 forming a cylindrical or tubular casing.

The lower portion of the form fitting material 32 may have a rear perforation 34 and a front perforation 36. The rear perforation 34 and front perforation 36 may be shaped to substantially align respectively with the rear (also referred to as pushing) aperture and the front (also referred to as dispensing) aperture (respectively, 50 in FIGS. 5 and 60 in FIG. 6) of a dispenser can 20 when a stack of coasters 30 is inserted into the dispenser can 20. In an exemplary embodiment, the rear perforation 34 is of the same size and shape as the rear aperture, and the front perforation 36 is of the same size and shape as the front aperture. For convenience, the rear and/or front perforations in the sleeve enclosing the stack of coasters may not have been finished or completed as holes or openings at time of receipt by the user. The user may need to remove the appropriate material (as explained below) so as to complete the rear and/or front perforations as holes or openings that correspond to the rear and front apertures.

A stack of disks 30 may be placed into the open top end of a dispenser can 20 when there is no top or when a can top 40 is taken off of the dispenser can 20. If necessary, the portions of a form fitting material 32 designated to complete the rear perforation 34 and front perforation 36 may be removed prior to inserting a stack of disks 30 into the dispenser can 20. Alternatively, the portions of the form fitting material 32 designated by the rear perforation 34 and the front perforation 36 may be removed after inserting a stack of disks 30 into a dispenser can 20. For example, a stack of disks 30 may be within shrink-wrap material. The shrink-wrap material may include perforations that align with the rear aperture 50 and the front aperture 60 of a dispenser can. Additionally, in this example, the shrink-wrapped coasters are placed into the dispenser can so that the perforations are aligned with the apertures. Subsequently, the portions of the shrink-wrap material outlined by the perforations may be removed prior to or concurrently with the first dispensed coaster. In yet another example, the coasters may be removed from the entire shrink-wrap material and then placed into the dispenser can without any of the shrink-wrap material.

As a further example, a previously dispensed coaster may be replaced into the coaster dispenser. Thus, instead of being refilled with a new stack of coasters, a coaster dispenser may be refilled with a single new or used coaster or numerous previously used or new coasters.

An Exemplary Embodiment of Dispenser Top Member—FIG. 4

FIG. 4 illustrates an exemplary embodiment of a can top 40 (also referred to as a top member). The exemplary embodiment of a can top 40 may include a top side 41, which is the side of the top member pointing away from or outside of the housing or coaster dispenser. The top side 41 of the can top 40 may include a pull ring 42 that may be used to aid in removing the can top 40 from the housing or sidewall of the coaster dispenser.

In addition, the can top 40 may include a top mating area 46 so as to removably mate the can top with the housing or sidewall of the coaster dispenser. The can top 40 may be shaped to form an enclosed, substantially cylindrical coaster dispenser when the can top 40 is place on a dispenser can 20. Alternatively, the can top 40 may be shaped to form a replica of a soda or other beverage can when the can top 40 is placed on the housing or sidewall of the dispenser can 20. Pull ring 42 may be attached to the top side 41 of can top 40 so that pull ring 42 lies flat and substantially parallel to the upper horizontal surface (also referred to as top side) of the can top 40 when not in use. The pull ring 42 may be lifted vertically (i.e., perpendicular to the upper horizontal surface of the can top 40) and pulled away from the housing or sidewall of dispenser can 20 to remove the can top 40 from the dispenser can 20. For example, on a dispenser can 20 designed to look substantially like a beverage container or a soda can, the pull ring 42 may resemble a pull ring on a beverage container and may be lifted and pulled away from the replica beverage container to remove the can top 40 from the dispenser can 20.

As noted, a top mating area 46 may be utilized to secure a can top 40 into a housing or sidewall of a dispenser can 20. Top mating area 46 may be shaped to fit snuggly into the housing of the dispenser can 20. Alternatively, top mating area 46 may be shaped to provide a groove or latch system to secure a can top 40 into the housing of the dispenser can. For example, top mating area 46 may be shaped to “snap” into the housing of the dispenser can 20 equipped with a ridge or groove aligned to receive the top mating area 46. As another example, a top mating area 46 may be threaded to allow the can top 40 to screw into the housing of the dispenser can 20 having a threaded area to receive a threaded top mating area 46.

As further illustrated in FIG. 4, the can top 40 may have an underside 47 facing towards the interior of the housing of the dispenser can 20. A force element 48 may be attached to the underside 47 of a can top 40. The force element 48 may be configured so as to be disposed from the underside 47 of the can top 40 and to hang into and to be disposed into the interior of the housing of the dispenser can 20. The force element 48 may be used to apply a downward force on a stack of disks 30. The downward force may be in the direction of the bottom of the dispenser can. The downward force may be a force in addition to gravity to position the stack of disks in the interior of the housing so that the disks sit in the bottom of the housing. In other words, the force element 48 may act as a spring to position the stack of disks into the bottom of the housing of the dispenser unit.

The size of the force element 48 can vary depending on the desired effect. For example, the force element 48 may be configured so as to be in continual touch and force exertion onto the stack of disks—no matter the number of disks in the stack. Thus, a full stack of disks would find the force element 48 fairly compacted between the stack of disks and the underside of the can top. An almost empty stack of disks would find the force element 48 quite extended between the stack of disks and the underside of the can top. As another example, the force element 48 may be configured to touch the stack of disks and exert force only until a certain number of coasters have been dispensed. Thereafter, the force element 48 may not be effective in exerting force against the stack of disks or coasters in the housing of the dispenser can 20.

As noted immediately above, the force element 48 may apply a downward force until a predetermined number of disks 31a-n has been dispensed. Additionally, a force element 48 may be of any material and may take any configuration that delivers a downward force when in contact with a stack of disks 30. For example, a force element 48 may be made of cardboard or plastic and may be in a substantially hourglass shape as illustrated in FIG. 4.

Rear View of Exemplary Embodiment of Dispenser—FIG. 5

FIG. 5 illustrates a rear view of an exemplary dispenser can 20. As noted above, a rear (or pushing) aperture 50 may be set into and near the bottom of the housing or sidewall of the dispenser can 20. FIG. 5 illustrates that the rear aperture 50 is set diametrically opposed to and centered with respect to the front (or dispensing aperture) which is indicated in phantom in its position on the housing by dashed lines 51. The rear aperture 50 provides a user with access to the bottom coaster 53 of the stack of coasters set within the housing of the dispenser can. The access may allow a fingertip or other device to push a portion of the bottom coaster 53 towards the dispensing aperture for dispensing from the dispensing apparatus.

Furthermore, the rear aperture 50 may be small enough so that, when a stack of disks 30 is inserted into the housing of the dispenser can, the bottom disk 53 may not pass through the rear aperture 50. The rear aperture 50 may be substantially oval, substantially semi-oval, or arched aperture to allow the insertion of a fingertip or other device. In this example, a fingertip is inserted into a rear aperture 50 to push the bottom coaster 53 towards the front aperture 60 (front aperture 60 is further described below in relation to FIG. 6). As a result of the push, the bottom coaster 53 moves through or at least partially through the front aperture. If the bottom coaster 53 does not pass all the way through the front aperture, it is a simple matter for the user to pick the bottom coaster 53 from the front aperture.

As described above in relation to FIG. 1, the rear aperture 50 may be substantially diametrically opposed and centered with respect to the front aperture 60. Additionally, the rear aperture 50 may be formed near the bottom of a housing or sidewall 22 of a dispenser can 20 by removing or excluding a portion of the housing or sidewall 22 of a dispenser can 20. Alternatively, the rear aperture 50 may be formed by removing or excluding a portion of both the sidewall 22 and the bottom of a dispenser can 20.

Front View of Exemplary Embodiment of Dispenser—FIG. 6

A front view of an exemplary dispenser can 20 is illustrated in FIG. 6. As referenced above in relation to FIG. 5, at least a portion of a bottom disk 53 may be visible through front aperture 60. Additionally, the front aperture 60 is sized at least large enough to allow a bottom disk 53 of a stack of disks 30 to pass completely through the front aperture 60. The front aperture 60 may be shaped to allow a larger portion of a dispensed bottom coaster 53 to be gripped for removal of the disk 53 from the dispenser can 20. For example, the front aperture 60 may be substantially oval, substantially semi-oval, or arched opening to allow a bottom coaster 53 to pass completely through front aperture 60.

Alternatively, the front aperture may take on a number of other shapes and configurations so as to allow for the dispensing of a coaster from the dispenser can. As a further example, front aperture 60 may include an additional tab-like opening above or below and connected to allow a user to more easily pull a bottom coaster 53 out of a dispenser can 20. As yet another example, a front aperture 60 may be substantially rectangular in shape, allowing a bottom coaster 53 to pass completely through the front aperture 60.

Moreover, the front aperture 60 may be shaped so that only the bottom disk 53 may be dispensed. Thus, a front aperture 60 may be of a height only slightly larger (or higher) than a single disk or coaster so that only one coaster at a time is dispensed through the opening. Alternatively and/or additionally, a front aperture 60 may have tapered corners or ends. The tapered ends may be set to a predetermined height so that no more than a single disk is allowed to pass completely through a front aperture at a time. As a final example, the front aperture 60 may have an elongated half circle shape with a flat side towards the bottom of the dispenser can and the arc side above the flat side. The flat side of the front aperture may include an opening just slightly wider (or longer) than the diameter of a coaster so as to allow a coaster to pass through the bottom (or flat side) of the front aperture. The arc side of the front aperture effectively holds back the coasters immediately above the bottom coaster so that only the bottom coaster is dispensed with the push applied through the rear aperture.

An Exempilar Embodiment of the Dispenser in Closed Position—FIG. 7

FIG. 7 illustrates an exemplary embodiment of the dispenser can 20 in a closed position. To achieve the closed position, a can top 40 may be placed onto the top of the dispenser can 20. As illustrated, a top mating area 46 fits snugly into the opening of the dispenser can 20. When the can top is fitted to the housing of the dispenser can, the force element 48 is disposed from the can top 40 into the interior of the dispenser can 20. The force element applies a downward force on a stack of disks 30. A force element 48 may be of sufficient length to provide a downward force until a predetermined number of disks 31a-n of a stack of disks 30 are dispensed, after which the stack of disks 30 may not be in contact with the force element 48. Alternatively, of course, a force element 48, may not apply a force on any disks 31a-n, such as if there are no disks in a dispenser can 20.

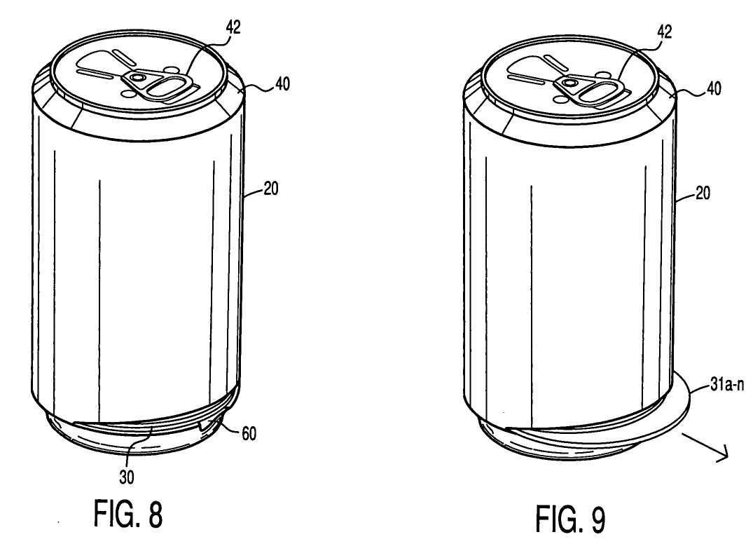

An Exemplarv Embodiment of Coaster Filled Dispenser—FIG. 8

FIG. 8 illustrates an exemplary embodiment of a stack of disks 30 inside of a dispenser can 20. In an exemplary embodiment of the invention, as referenced above in relation to FIG. 5 and FIG. 6, at least a portion of a bottom disk 53 of a stack of disks 30 may be visible from a rear aperture 50 and/or a front aperture 60. Thus, in an exemplary embodiment of the invention, it may be possible to visually inspect a dispenser can 20 to determine whether the dispenser can 20 needs to be refilled without having to remove the can top 40 from the dispenser can 20.

In an exemplary embodiment of the invention, if at least a single disk remains in a dispenser can 20, the disk may be at least partially dispensed from the dispenser can 20. Placing a fingertip into rear aperture 50 and pushing at least a portion of disk 31n out of a front aperture 60 may dispense a disk 31n. Alternatively, an object sufficient to penetrate rear aperture 50 may be used instead of a fingertip. For example, a pencil or pen may be used to push disk 31n instead of a fingertip.

An Exemplary Embodiment of Coaster being Dispensed—FIG. 9

FIG. 9 illustrates a disk 31n being dispensed from an exemplary dispenser can 20. To at least partially dispense disk 31n from the stack of disks 30, a finger may be placed into a rear aperture 50 and a bottom disk 31n may be pressed toward a front aperture 60 until the bottom disk 3ln protrudes from the front aperture 60. The bottom disk 31n may then be pulled out of the dispenser can 20. Subsequently, the disk directly above disk 3 in becomes the bottom disk and is the next disk dispensed. Thus, the dispensing of the disks 31a-n from a dispenser can 20 follows a first in first out order.

### CONCLUSION

From the foregoing description of the exemplary embodiments of the inventions and operations thereof, other embodiments will suggest themselves to those skilled in the art. Therefore, the scope of the inventions is to be limited only by the claims below and equivalents thereof.

What is claimed is:

1. An apparatus to dispense coasters, the apparatus comprising:
a housing for storing a stack of coasters;
the housing having a dispensing aperture near the bottom of the housing;
the dispensing aperture being of a size large enough to allow the bottom coaster of the stack of coasters to pass from the stack of coasters in the housing through the dispensing aperture of the housing to outside the housing; and
the housing having a pushing aperture near the bottom of the housing with the pushing aperture being set opposite to the dispensing aperture, and with the pushing aperture being of a size large enough to allow access to the bottom coaster for pushing the bottom coaster towards the dispensing aperture of the housing,
whereby using the pushing aperture to access the bottom coaster from the stack of coasters so as to push the bottom coaster through the dispensing aperture results in dispensing of the bottom coaster from the housing.

2. The apparatus of claim 1, wherein the housing comprises a cylindrical can.

3. The apparatus of claim 1, wherein the dispensing aperture is large enough to allow only the bottom coaster of the stack of coasters to pass from the stack of coasters in the housing through the dispensing aperture of the housing to the outside of the housing.

4. The apparatus of claim 1, wherein the dispensing aperture is slightly wider than a diameter of the bottom coaster of the stack of coasters.

5. The apparatus of claim 1, wherein the dispensing aperture comprises an elongated half circle having a flat side and an arc side,
wherein the flat side of the elongated half circle is perpendicular to a vertical axis of the stack of coasters in the housing, and
wherein the flat side of the elongated half circle is slightly longer than a diameter of the bottom coaster of the stack of coasters.

6. The apparatus of claim 5, wherein the arc side of the dispensing aperture prevents dispensing of any coaster other than the bottom coaster.

7. The apparatus of claim 1, wherein the stack of coasters is replenished by adding additional coasters to a top of the stack of coasters in the housing from the top of the housing.

8. The apparatus of claim 1, further comprising a top member removably fitted to the top of the housing,
the top member having an underside facing into the interior of the housing, and
the underside having a force member disposed thereon so the force member is disposed from the underside of the top member into the interior of the housing and so as to touch the stack of coasters and exert force on the stack of coasters and towards the bottom of the housing.

9. The apparatus of claim 8, wherein the top member comprises an outside facing away from the housing, and
the outside comprises a pull ring for use in removing the top member from the housing.

10. The apparatus of claim 1, wherein the stack of coasters is encompassed by a sleeve with a front perforation conforming to the size of the dispensing aperture and with a rear perforation conforming to the size of the pushing aperture.

11. The apparatus of claim 1, wherein each coaster in the stack of coasters is substantially round and is substantially the same size of each other coaster in the stack of coasters.

12. The apparatus of claim 1, wherein the housing comprises a cylindrical can having a diameter slightly larger then a diameter of the stack of coasters.

13. A method of storing and dispensing coasters, comprising:
placing a plurality of coasters in a housing having a dispensing aperture near the bottom of the housing, and having a pushing aperture opposite to the dispensing aperture and near the bottom of the housing; and
using the pushing aperture to access a bottom coaster of the plurality of coasters and to exert pressure on the bottom coaster to move the bottom coaster through the dispensing aperture.

14. The method of claim 13, further comprising:
fitting a top member onto the top of the housing with the top member having a force member disposed on the underside of the top member and into the interior of the housing so as to touch the stack of coasters and to exert force on the stack of coasters with the force directed towards the bottom of the housing.

15. The method of claim 14, further comprising:
causing the top member to be removable from the housing.

16. The method of claim 15, wherein the top member is removable by using a pull ring disposed on the outside of the top member.

17. The method of claim 13, further comprising:
causing the stack of coasters to be enveloped by a sleeve with a front perforation conforming to the size of the dispensing aperture and with a rear perforation conforming to the size of the pushing aperture.

18. A coaster dispenser comprising:
a cylindrical can shaped substantially like a beverage can for holding at least a coaster; and
the cylindrical can having a dispensing aperture and a pushing aperture set near its bottom, and with the pushing aperture set opposite to the dispensing aperture,
whereby using the pushing aperture to access and to push the coaster towards the dispensing aperture causes the coaster to be dispensed from the cylindrical can.

19. The coaster dispenser of claim 18, further comprising:
a top member removably fitted to the top of the cylindrical can for access to replenish coasters held in the cylindrical can.

20. The coaster dispenser of claim 19, wherein the top member comprises an underside facing the interior of the cylindrical can, and wherein a force member is disposed on the underside of the top so as to be disposed into the interior of the cylindrical can and to exert force on coasters in the cylindrical can with the force directed towards the bottom of the housing.
